(19) United States
(12) Patent Application Publication
(10) Pub. No.: US 2004/0061025 A1
(43) Pub. Date: Apr. 1, 2004

(54) AERODYNAMICS OF SMALL AIRPLANES

(76) Inventor: Clifford Bernard Cordy JR., Reno, NV (US)

Correspondence Address: Dr. Clifford B. Cordy Jr., 6402 Mae Anne #20, Reno, NV, 89523, US

(21) Appl. No.: 10/260,252

(22) Filed: Sep. 30, 2002

(51) Int. Cl. B64C 3/28; B64C 39/12

(52) U.S. Cl. 244/45 A

(57) ABSTRACT

The inventions described here provide better aerodynamics in small airplanes. They were specifically developed to optimize performance of a single-engine, canard airplane with the engine in front. Some are applicable to other types of airplanes. The specific improvements are: locating the canard so the main spar passes in front of the engine; mounting the front of the engine directly to the canard structure; mounting flaps on both the canard and main wing; making the canard function as an elevon; building a full flying canard; building the main wing with two spars and seating the people between them; using a forward pointing steering arm on the rudder.

Each of these innovations reduces the aerodynamic drag on the airplane in flight. This results in higher top speed, better rate of climb, higher ceiling, and better fuel efficiency. Some of the innovations also provide better landing characteristics. Some also reduce total weight for even greater performance gains, especially for rate of climb.

### RELATED APPLICATIONS—NONE

### FEDERALLY SPONSORED RESEARCH OR DEVELOPMENT—NONE

### INNOVATIONS TO BE COVERED

A Canard

1 Canard in front of the engine

2 Engine mounted to canard spar

3 Canard with elevons

4 Full flying canard

5 Flaps on both wing and canard

B Seating within wing having double spars

C Totally enclosed, forward pointing rudder arm

### ABBREVIATIONS AND CONVERSION FACTORS

TAS—true air speed

CG—center of gravity

m/s—meters per second

km/l—kilometers per liter

1 m/s=2.2374 mph (used for speed)

1 m/s=196.85 ft/min (used for rate of climb)

1 km/l=2.252 mpg (used for fuel consumption)

### BACKGROUND

Canard airplanes are inherently more efficient and safer than airplanes with a horizontal tail. The canard lifts where the horizontal tail pushes down. Hence there is less lift induced drag in a canard airplane. A properly loaded canard airplane cannot stall or spin. Hence it is safer. Still, canard airplanes have never been very popular. Existing designs have compromises that limit their usefulness. The major compromises include a severely limited range of position for the center of gravity (CG) and high takeoff and landing speeds.

In the last couple decades, experimental aircraft builders have made significant improvements in the performance of small planes. Some of these deserve mention here because some of the innovations described in this application are extensions to their work. First, the major proponent of canard aircraft is Burt Rutan. His best known planes are the VARI-EZE (which spawned a whole family of canard aircraft) and the Voyager (which flew around the world without refueling). A good quality VARI-EZE typically reaches a top speed of 90 m/s. Second, the most popular homebuilt planes in the world are the RV family, designed by Dick Van Grunsven. These are conventional airplanes with horizontal tails. A good quality RV typically reaches a top speed of 90 m/s. Both these designs fly about twice as fast as a small Cessna (for example) using little, if any, more power. Thus they go about twice as far on any given amount of fuel.

Klaus Savier, Santa Paula, Calif., built the world's fastest VARI-EZE. He increased the power produced by the standard engine by about 30% (which should give a 9% speed increase to about 98 m/s) and has streamlined a VARI-EZE to reach top speeds of about 110 m/s and fuel economy of 21 km/l at 90 m/s. Dave Anders, Visalia, Calif., built the world's fastest RV-4. He boosted the power by 50% (which should give a 15% speed increase to 103 m/s) and has streamlined it to reach a speed of 122 m/s. The work of both these builders is well known within the experimental aircraft community.

Another airplane that deserves mention is the AR-5, which was designed from scratch by Mike Arnold. It is a conventional style airplane with outstanding aerodynamics. It is a one place airplane powered by an engine producing 45 kW. It flew 93 m/s in level flight and set a world record of 95 m/s for airplanes weighing under 300 kg in flight. (The official race rules allow some descent over the measured distance.) There are no plans or detailed information about this airplane. It has been studied carefully only by a few specialists at the invitation of the owner/builder. One known problem in the airplane is that the engine overheats with little provocation. Marginal cooling is one solution to the cooling drag problem. This might be acceptable for a single purpose airplane designed to break a speed record, but it is not acceptable in a general purpose aircraft.

One big disadvantage of the EZ family is the limited range of CG with which it can be flown safely. This results in the condition that, on the ground, the plane falls over backward when the pilot is not in it. The EZ airplanes are tricycle gear planes with the engine in the rear. If it falls over backward, it generally causes serious damage. The main disadvantage of the RV family is that they are conventional airplanes, hence can stall and spin if the speed is not high enough. Neither family of airplanes is designed to be as aerodynamic as desirable and the exceptional performance achieved by Klaus and Dave are the result of considerable investment of personal time and ingenuity.

There is no prior single engine canard airplane that has a reasonably wide range of allowable CG position. The main difficulty in designing a single engine canard airplane is that the engine must be at the front or rear of the airplane, not on the wing, as is possible in a twin engine airplane. Placing the engine above the airplane is theoretically possible, but that introduces a whole set of undesirable mechanical and aerodynamic problems. In existing airplanes with the engine in front, as in the Quickie family, the canard has to carry the majority of the weight of the airplane. This forces the canard to be large, and it almost becomes the wing. To keep the wing far enough forward to function as a wing instead of a horizontal stabilizer, the distance from the wing to the canard must be small. This results in an undesirably critical location of the CG. If the engine is in the rear, as in the EZ family, and in the original incarnation of the race airplane named Pushy Galore, the wing carries most of the weight, but the pusher configuration introduces a new set of limitations, including the impossibility of making a taildragger configuration (with a small tail wheel as opposed to a nose wheel) and less efficient engine cooling.

No existing canard airplane that is designed to fly fast provides the ability to fly and land at low speeds. In conventional aircraft, slow flight is achieved by using wing flaps. In a canard design, the use of wing flaps would actually increase the minimum flying speed.

### SUMMARY

This invention consists of several improvements to the aerodynamics of small airplanes. While the impetus for these innovations is improving the performance of canard aircraft with front engines, several of the novel designs are also applicable to conventional aircraft with horizontal tails and also to pusher aircraft. The specific improvements presented here are: The canard is located in front of the engine to give a wider range of acceptable CG locations. The engine is mounted directly to the canard structure. The control surfaces on the canard are elevons, eliminating the need for control surfaces on the wing. A “full flying” canard is used to achieve more control authority from the control surfaces. Flaps are mounted on both the wing and canard to give the ability to fly slower without increasing the size of the wing and canard (which would increase drag). The wing contains two spars, allowing the pilot and passenger to sit in the wing, rather than on it, reducing the frontal and surface areas of the fuselage. The rudder control mechanism is much narrower, allowing it to be completely enclosed within a fuselage of normal width, thus eliminating aerodynamic drag.

### BRIEF DESCRIPTION OF THE ILLUSTRATIONS

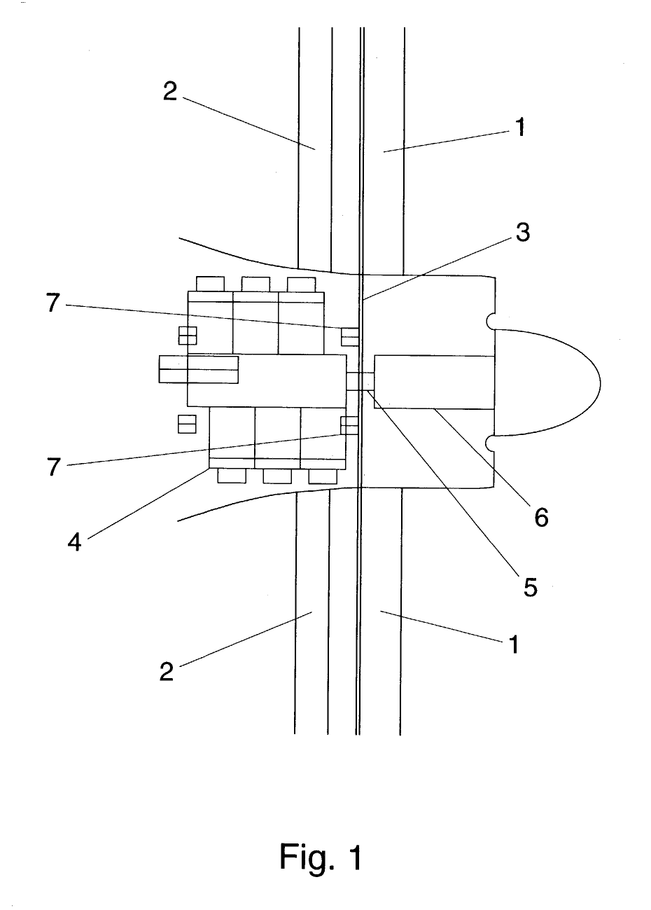

FIG. 1 is a top view of the front of the airplane showing the location of the canard with its spar located in front of the engine.

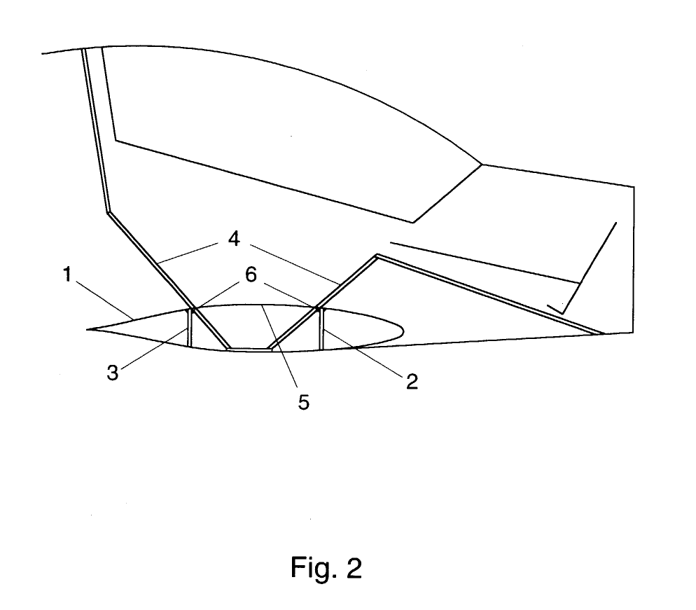

FIG. 2 is a side view of a section of the airplane cabin showing the seat located within the wing, between the two main wing spars.

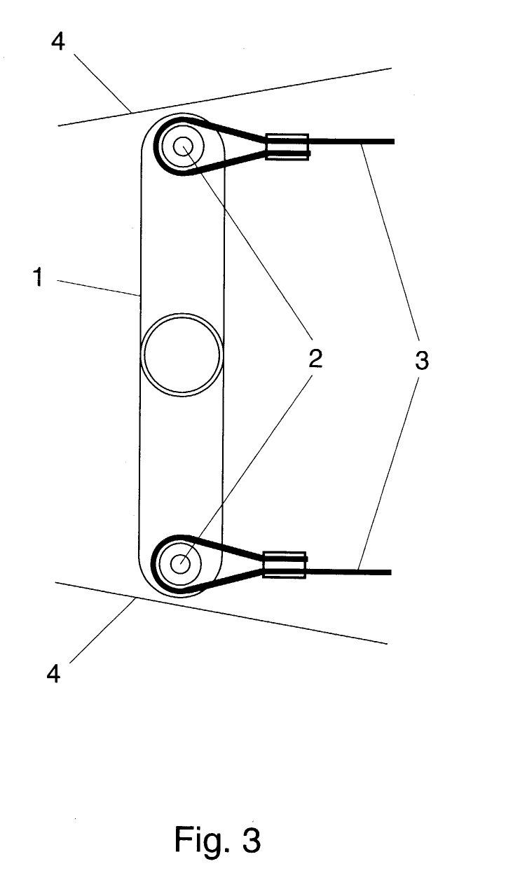

FIG. 3 is a top view of a standard rudder steering assembly.

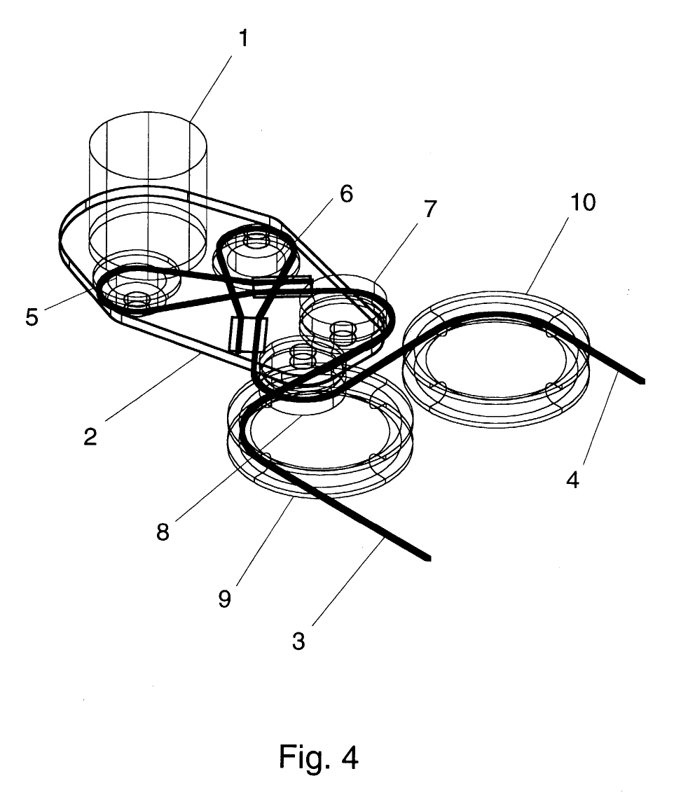

FIG. 4 is an isometric view of a much narrower rudder steering assembly.

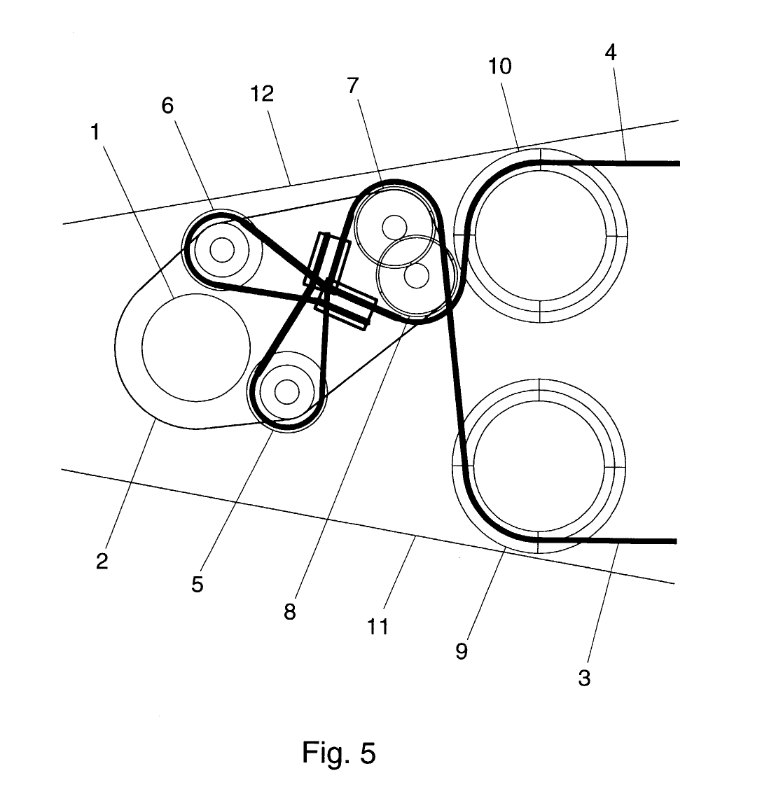

FIG. 5 is a top view of the new, narrow rudder steering assembly with the rudder at the maximum right turn position.

### DETAILED DESCRIPTION OF THIS INVENTION

Canard Location

The secret of success in designing a canard airplane with a single engine in front is to get the canard far enough forward that it does not carry too much weight. In the Quickie family, the canard is located just below and behind the engine. If everything is balanced just right, this is not a terrible situation, especially at high speed. But the big canard, heavily loaded, and big elevators, generate excess lift induced drag and control surface drag, especially at lower speeds such as at takeoff, landing, and during maximum climb. The lift induced drag also increases with altitude, limiting the altitude that the plane can reach, and limiting its speed at altitudes it can reach. It would be desirable to move the canard forward and place the engine in the center of the canard. Structurally, this is impractical. It would be very difficult to build a structure that maintains the required strength of the canard and still allows the required access to the engine. Placing the canard under the engine would compromise the aerodynamics of the airframe. Placing the canard over the engine would not only compromise the aerodynamics, it would also interfere with the view of the pilot.

This novel design places the canard somewhat in front of the engine. This has never been done before. The main disadvantage is that a long prop extension is required to give sufficient clearance between the propeller and the canard. There are many advantages. This far-forward canard carries a smaller fraction of the total weight, giving aerodynamic advantages in the lift induced drag and control surface drag (relative to a Quickie, for instance). The CG has a much wider range of acceptable locations. The front of the engine can be mounted directly to the canard (which basically is carrying the engine in any case) rather than having those forces transmitted thru the airframe. Of course, adequate structure must be provided to keep the canard attached to the rest of the airplane. Depending on the design details, this will generally be simpler and lighter than the structure required for a bed mounted engine. If the airplane is tricycle gear, the nose wheel can be mounted to the canard structure also. The nose wheel carries much of the engine weight on the ground, relieving stress on the fuselage structure caused by a hard landing.

The best, though not the only, implementation of this arrangement is shown in FIG. 1. The canard (1) with elevator (2) has a spar (3) that passes just in front of the engine (4) and just below the propeller shaft (5). The spar should be located as far forward as practical within the canard. This locates the canard as far back as possible, in order to minimize the length of the prop extension (6). Furthermore, the location off the spar (3) is such that it is easy to connect the front engine mounts (7) to it.

This innovation, placing the canard in front of the engine, gives greater tolerance to CG location, reduces stresses in the air frame, and improves aerodynamics.

Canard with Elevons

Elevons (a combination of elevator and aileron in a single control surface) are a well known but seldom used control configuration. The elevon is mechanically the same as an elevator except the linkage is such that the two control surfaces can be moved in opposite directions to produce a roll moment. The aileron is eliminated entirely, producing a simpler, lighter, aerodynamically cleaner wing. The usual limitation of an elevon design is that there is insufficient roll control. A few conventional aircraft do use elevons. Elevons were tried on some very early VARI-EZEs, but with their very small canard, there was not enough roll control. In a design with a larger canard, as in the Quickie family, canard elevons would probably work, but they were never tried. With a reasonable size canard located in front of the engine, using elevons for roll control should be a satisfactory configuration.

This innovation, using elevons on a canard airplane with the engine in front, eliminates the need for an aileron, and results in a simpler, lighter, more aerodynamic wing.

Full Flying Canard

A canard (or horizontal tail) usually has some fraction of the surface hinged for the elevator function. The entire canard (or horizontal tail) could be rotated as an elevator. This is rarely done. The problem is that the angle of attack becomes too large and the surface stalls before there is enough response to the elevator function. A “full flying tail” is a structure where the entire horizontal tail rotates a small amount and the elevator part of the tail rotates considerably more. The linkage that accomplishes this is well known and very simple. This gives very good elevator response. This new innovation extends the concept of a full flying tail to the canard and creates a full flying canard. The control linkages are the same as in the full flying tail.

With the control power of a full flying canard, elevons become practical on a small canard. This is an additional innovation, which is also applicable in the horizontal tail. There has never been a full flying canard. There has never been a full flying tail used as an elevon. There certainly has never been a full flying canard used as an elevon.

These innovations, the full flying canard and the full flying elevon, give improved roll authority to the canard and elevon, eliminating the need for an aileron, and making a simpler, lighter, more aerodynamic wing.

Canard Flaps

Most canard airplanes do not have flaps. The reason is simple. In a canard airplane, wing flaps are counterproductive. A flap does three things. It increases the maximum coefficient of lift. It decreases the angle of attack for any given coefficient of lift. It also moves the center of lift aft. A wing flap, moving the center of lift aft, increases the load on the canard, and increases the minimum achievable flying speed. Since canard airplanes do not have flaps, their landing speeds are typically 20% to 30% higher than conventional aircraft with similar wing loading. This is undesirable. A canard flap alone is unacceptable because the lifting capacity of the canard could be increased to the point that the wing might stall, with likely fatal consequences.

A novel solution to the high landing speed problem is to put flaps on both the wing and canard with the linkage coordinated so the canard flaps cannot be used without the wing flaps. In this configuration, the maximum coefficients of lift of both flying surfaces are increased by similar amounts, yielding lower flight (and landing) speeds. Ideally, the flaps on the canard would be made slightly more powerful than the wing flaps. This would compensate for the aft movement of the center of lift as the flaps are deployed.

Wing flaps provide an additional factor of safety. If the pilot manages to load the airplane with the CG aft of the acceptable range, and then flies too slowly, the wing and canard can get into a condition where neither of them can support their load, and there is enough flow separation that the elevators lose their effect. The plane descends rapidly, although it does not plummet, and the landing will likely break the airplane, even if it is on a smooth, level surface. This condition has occurred in the Quickie II. In this condition, deploying only the wing flaps slightly (into the non-separated air flow below the wing), but not the canard flaps, will increase the lift of the wing, move the center of lift aft, cause the plane to rotate nose down, pick up speed, and recover from the impending stall condition.

The wing flaps can be the same as are found on most conventional aircraft. The canard flaps could be something as simple as having the elevator motion accommodate a larger than usual range of downward motion. The elevator motion is limited by a linkage to the wing flap control to prevent the elevator from extending too far down unless the wing flap is extended. The canard flaps could also be made larger than the elevator and be controlled directly by the flap control mechanism. There is nothing necessarily unique in the mechanisms that drive the flaps and elevators. The unique innovation is the use of flaps on the canard.

This innovation, providing flaps on both the wing and canard, and having them linked so the canard flaps cannot be deployed without deploying the wing flaps, allows lower flight and landing speeds. It also improves safety margin by providing a means for recovery from an impending stall where the elevator has lost its ability to pull the nose down.

Wing Structure

In a single-place airplane, or a two-place, side-by-side airplane, with the canard in front of the engine, the people will sit at approximately the center of the chord of the wing. For minimum air drag, the frontal (and total surface) area of the fuselage should be minimized. This is best done by having the people sit on the floor of the airplane in a recumbent position. In this position, the people and the wing must occupy the same volume of space. This could be uncomfortable. In the past the solution has been to yield on the desire for minimal areas and have the people sit on top of the wing, as in the AR-5. Several other airplanes are designed so the people sit below the level of the top of the wing, but far enough aft with respect to the wing that the wing spar (or equivalent structure) passes under their knees. Having the seats within the wing structure (instead of behind it) keeps the people closer to the desired CG of the airplane. Thus there is less effect on balance from the number, or size, of people in the airplane.

A novel solution to the problem is to have the people sit in the wing, as shown in FIG. 2. This is achieved by building the wing (1) with two spars (2 and 3) (or equivalent structure), instead of the usual one spar. The front spar (2) passes thru the fuselage under the thighs of the people, the rear one (3) passes thru the fuselage under their lower back. The seat (4) is shaped so the people do not feel like they are sitting on two railroad rails. The top surface of the wing (5) is interrupted where it passes thru the cockpit, the loss of strength being made up by bands of fiber (6) near the tops of the spars (2 and 3).

This innovation, using a wing with two spars and seating the people within the wing structure, minimizes the frontal and surface areas of the fuselage, thus reducing aerodynamic drag and improving performance.

Totally Enclosed Rudder Control

In most small airplanes, the rudder pedals control a pair of cables connected to an inverted T-shaped structure at the base of the rudder, with the arms of the T extending sideways from the rudder shaft. This is shown in FIG. 3. The rudder cables (3) are connected to the steering arms (1) at a flexible joint (2). It is hard to beat this configuration for simplicity and reliability. However, the steering arms (1), the ends of the cables (3), and the connection between the two (2) are usually located in the high speed air flow passing over the airplane, and they are generally high drag components. Sometimes they are enclosed in protrusions from the sides of the fuselage to reduce aerodynamic drag. Typically the lever arm for the rudder cable attachment (2) is 50 mm. To enclose this assembly within the skin of the airplane (4) would require the fuselage to be a minimum of 120 mm wide at the position of the rudder shaft. This would increase the total surface area of the airplane so much that it has more drag than the external rudder cable assembly. Building a protrusion to house the steering arms does improve aerodynamics somewhat, but it is not a clean solution.

The aft end of the fuselage (not including the tail) is typically more or less conical with an apical half angle of about 10°. This is shown in FIGS. 3 and 5.

The innovation presented here is a simple mechanism that is much narrower than existing steering mechanisms. This allows the entire steering mechanism to be contained within the fuselage, eliminating air drag and maximizing speed and efficiency. The new mechanism is shown in FIG. 4 and FIG. 5. FIG. 4 is an isometric view with the rudder pointed straight back, and the steering arm pointed straight forward. FIG. 5 is a top view with the rudder 25° to the right, typically the maximum desired movement. The rudder shaft (1) is connected to a forward pointing steering arm (2). Rudder cable (3) follows a path above the rudder arm (2). Rudder cable (3) is anchored to the rudder arm (2) at a termination (5) that need not be flexible. From there it passes around the fixed turning post (7) which is mounted on the rudder arm (2) and around the pulley wheel (9) which is mounted to the fuselage. The other rudder cable (4) follows a mirror image path below the rudder arm (2). Rudder cable (4) is anchored to the rudder arm (2) at a termination (6) that need not be flexible. From there it passes around the fixed turning post (8) which is mounted to the rudder arm (2) and around the pulley wheel (10) which is mounted to the fuselage. This entire assembly, except for the forward pointing rudder arm (2) and turning posts (7 and 8) can be built with standard aircraft parts. As can be seen in FIG. 5, this rudder steering mechanism can be entirely housed between the walls of the fuselage (11 and 12) with very little more total width at the rudder shaft (1) than the lever arm of the steering cables (3 and 4), typically 50 mm. This is only 40% of the width required by the conventional steering gear. For reasons of structural strength and rigidity, it is generally undesirable to make the aft end of the fuselage that narrow. Thus, the width of the aft tip of the fuselage is no longer limited by the steering mechanism.

In theory, a simpler assembly could be built if the rudder control cables were magically attached to the front of the forward-pointing rudder control arm. Unfortunately, magic is not reliable enough for aircraft applications, and existing, approved hardware for terminating cables are the sizes shown in FIGS. 4 and 5.

The novel parts of this design are the use of guide wheels (9 and 10) and turning posts (7 and 8) to connect the rudder cables (3 and 4) to a forward pointing arm (2) which can rotate thru its required range of motion totally within the skin of the fuselage. This eliminates air drag associated with the rudder control mechanism

1 An airplane comprising an engine located toward a front end of said airplane, a propeller mounted ahead of said engine, a main wing located near a center of said airplane, a vertical stabilizer and rudder mounted at the rear of the said airplane, and a canard mounted to said airplane with a main structure of said canard located in front of said engine.

2 An airplane as described in claim 1 wherein said engine is mounted to said canard structure.

3 An airplane as described in claim 1 wherein said canard comprises control surfaces functioning as elevons.

4 An airplane as described in claim 1 wherein said canard operates as a full flying canard.

5 An airplane as described in claim 1 further comprising flaps mounted on both said main wing and said canard.

6 An airplane comprising a low wing further comprising two mechanically strong structures, said structures allowing the people seated in said airplane to sit between said structures, positioned below a level of a top surface of said wing.

7 An airplane comprising a rudder control mechanism with a single, forward-pointing arm capable of moving thru its required range of travel within the width of a fuselage of said airplane, said fuselage being substantially as wide as the thickness of a root of a vertical stabilizer.
